(19) United States
(12) Patent Application Publication
(10) Pub. No.: US 2007/0250855 A1
(43) Pub. Date: Oct. 25, 2007

(54) Search engine for presenting to a user a display having both graphed search results and selected advertisements

(75) Inventors: David Quinn-Jacobs, Ithaca, NY (US); Patrick T. Igoe, Philadelphia, PA (US)

Correspondence Address: TECHNOLOGY, PATENTS AND LICENSING, INC., 2003 South EASTON ROAD, SUITE 208, DOYLESTOWN, PA, 18901, US

(73) Assignee: Graphwise, LLC

(21) Appl. No.: 11/401,673

(22) Filed: Apr. 10, 2006

(51) Int. Cl. H04N 7/10; H04N 7/025

(52) U.S. Cl. 725/35; 715/968; 725/34

(57) ABSTRACT

A search engine is provided which responds to a user's queries by generating and presenting a graphed result. In addition to the graphed data, the user is provided with advertisement data which is related to the query information and/or to the nature of the data itself. One aspect of the invention selects advertisements to be displayed based on trends determined from the data presented on the graph.

### CROSS REFERENCE TO RELATED APPLICATION

The following identified U.S. patent applications are relied upon and are incorporated by reference in this application.

U.S. patent application Ser. No. ______ entitled “A System and Method for Creating a Dynamic Database for use in Graphical Representations of Tabular Data” (Attorney Docket No. GRA-002-US) filed on the same date herewith.

U.S. patent application Ser. No. ______ entitled “A System and Method for Presenting to a User a Preferred Graphical Representation of Tabular Data” (Attorney Docket No. GRA-003-US) filed on the same date herewith.

U.S. patent application Ser. No. ______ entitled “Search Engine for Evaluating Queries from a User and Presenting to the User Graphed Search Results” (Attorney Docket No. GRA-004-US) filed on the same date herewith.

U.S. patent application Ser. No. ______ entitled “Search Engine for Presenting to a User a Display having Graphed Search Results Presented as Thumbnail Presentation” (Attorney Docket No. GRA-005-US) filed on the same date herewith.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

The domain of most Internet search engines is textual data. A wealth of information is available as structured data, even though this is a tiny fraction of the textual data available. Moreover, this source of information has tremendous potential value to users—both in terms of the user friendly manner in which it can be presented (i.e. colorful graphs) and the amount of information that can be visually displayed to a user due to the implicit information inherent in such structured data.

The present invention presents to a user information obtained from structured data sources. That is, the present invention relates generally to data processing systems and, more particularly, to a system for Internet accessing sets of tabular data and presenting requested data to a user in a graphic format.

### BRIEF SUMMARY OF THE INVENTION

Briefly stated, the present invention relates to a search engine system for querying and displaying structured data. In various embodiments of the invention, users are permitted to enter simple keywords and/or advanced profiles which results in a set of “hits” being returned in graph form. These results may be ranked and ordered in terms of best fit.

In various embodiments, the present invention includes automated and human processes for retrieving raw data from various sources (to include Internet sources), profiling and storing structured data derived from this raw data, and retrieving this structured data in response to user queries. The invention utilizes a unique data storage architecture that optimizes the characterization of the structure data for querying.

Further embodiments of the invention comprise displaying the query response in a manner most preferred by one or more users, based upon an accumulated history of output format selections by one or more users. In still further embodiments the displayed results also comprise one or more advertisements that have been determined by the invention based upon the query input and/or the nature of the structured data obtained as a result of the query.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the Drawings:

FIG. 1A depicts an overall system view of an embodiment of the present invention;

FIGS. 1B-F illustrate various elements of FIG. 1A depicted in greater detail;

FIG. 2 depicts a screen shot of a query entry interface that is provided in accordance with one embodiment of the invention;

FIG. 3 depicts a screen shot displaying exemplary search results consistent with the present invention;

FIGS. 4A-D depicts a screen shot of a further embodiment of the invention wherein a secondary search is being conducted;

FIG. 5 depicts an exemplary screen shot of a home page in accordance with a further embodiment of the invention;

FIG. 6 depicts an exemplary screen shot of a search result wherein a map is displayed;

FIG. 7 illustrates a further embodiment of the invention wherein the query entry interface comprises entering search terms onto a graph axes;

FIG. 8 is a use case diagram for the overall system of an embodiment of the present invention;

FIGS. 9A-B are class diagrams containing attributes of various components of the system depicted in FIG. 8;

FIGS. 10A-E are flow diagrams of various processes related to embodiments of the invention; and,

FIGS. 11A-B are tables of exemplary trend rules for determining advertisements to be displayed with graphed results.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

The words “right”, “left”, “lower” and “upper” designate directions in the drawings to which reference is made. The terminology includes the words above specifically mentioned, derivatives thereof and words of similar import.

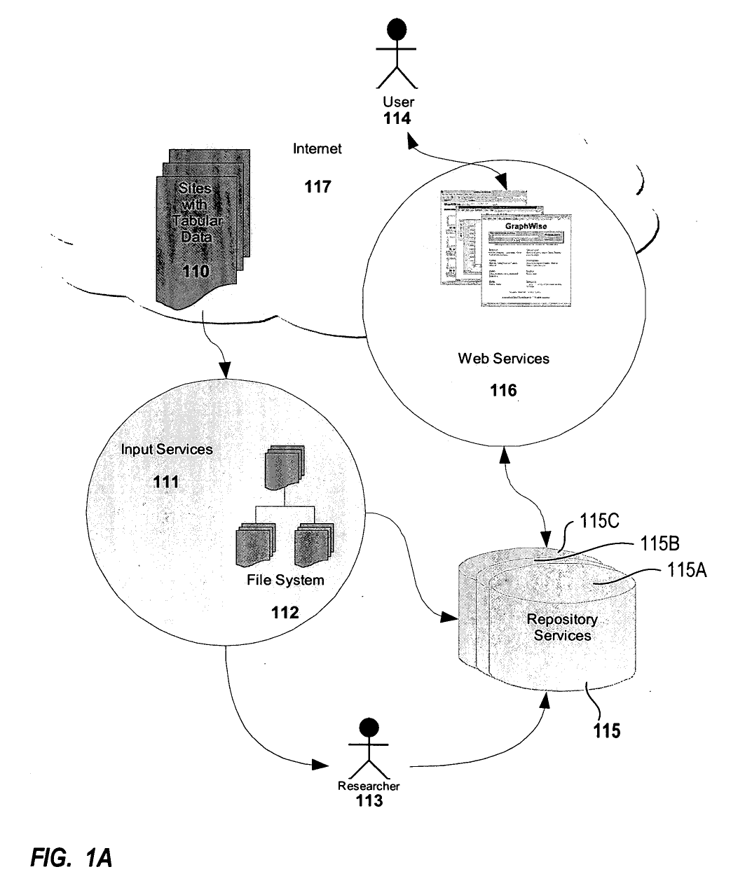

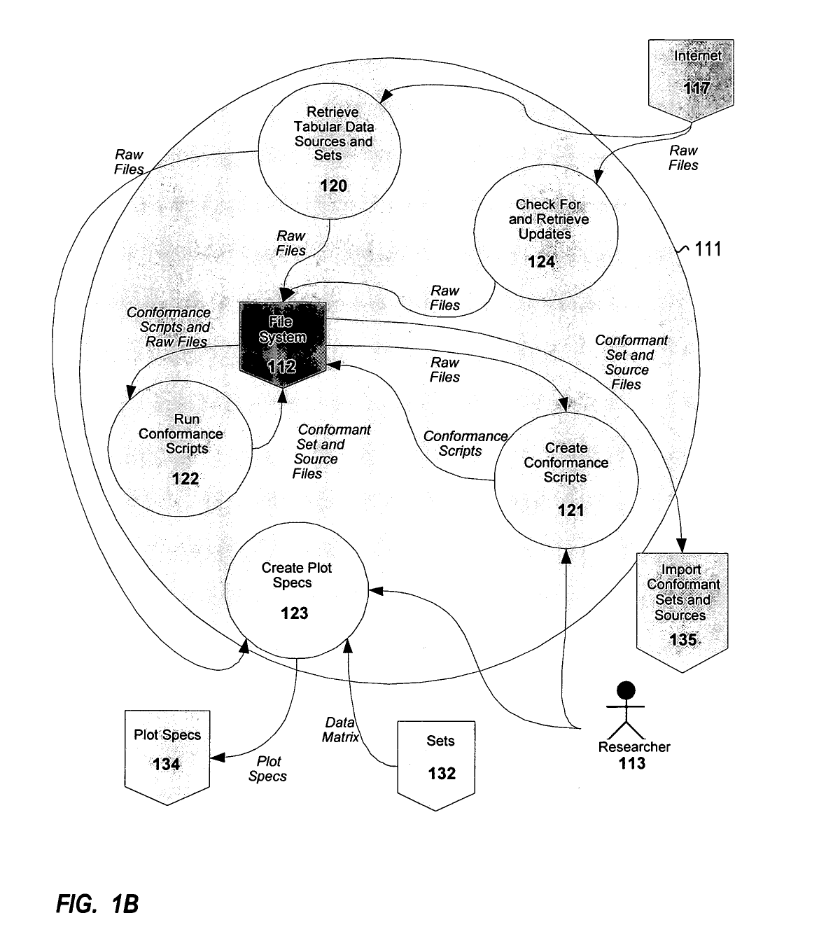

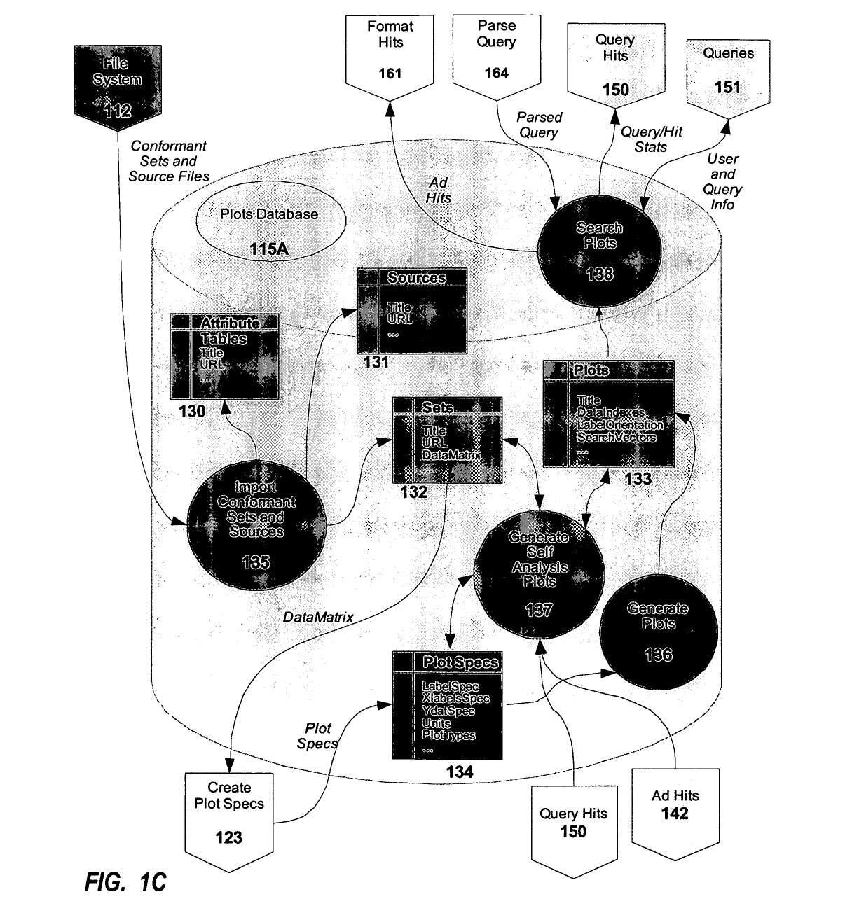

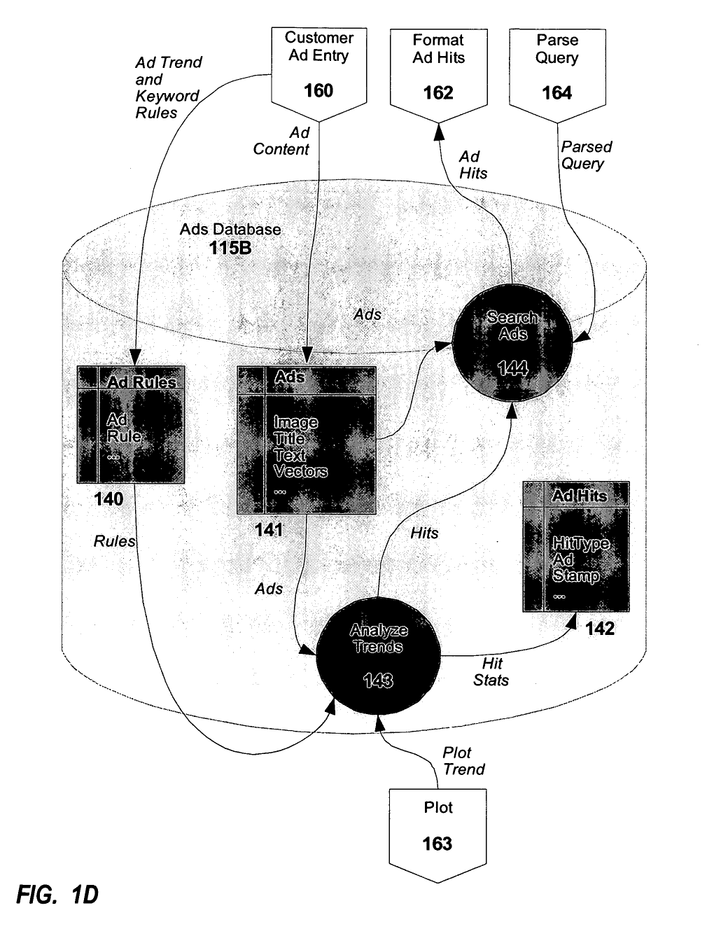

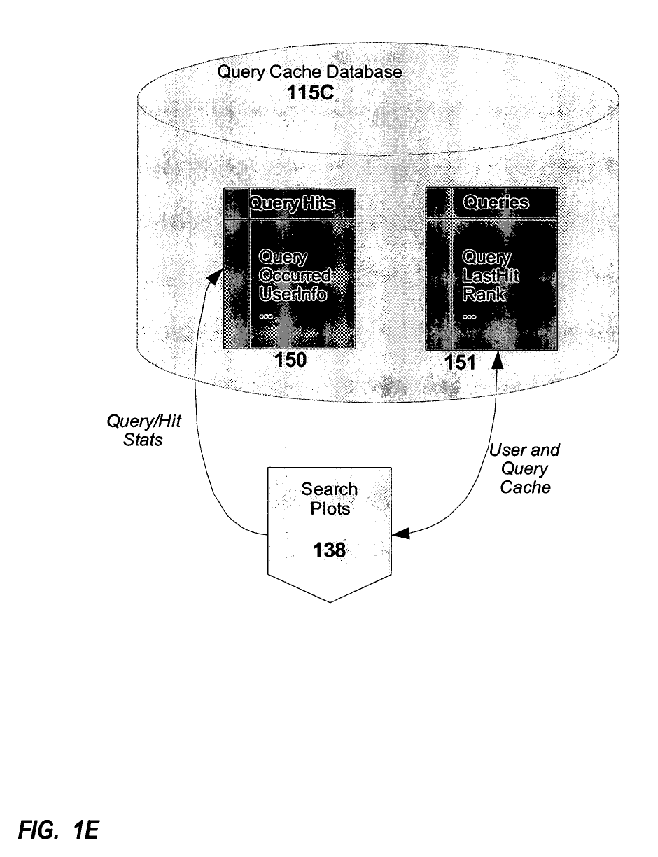

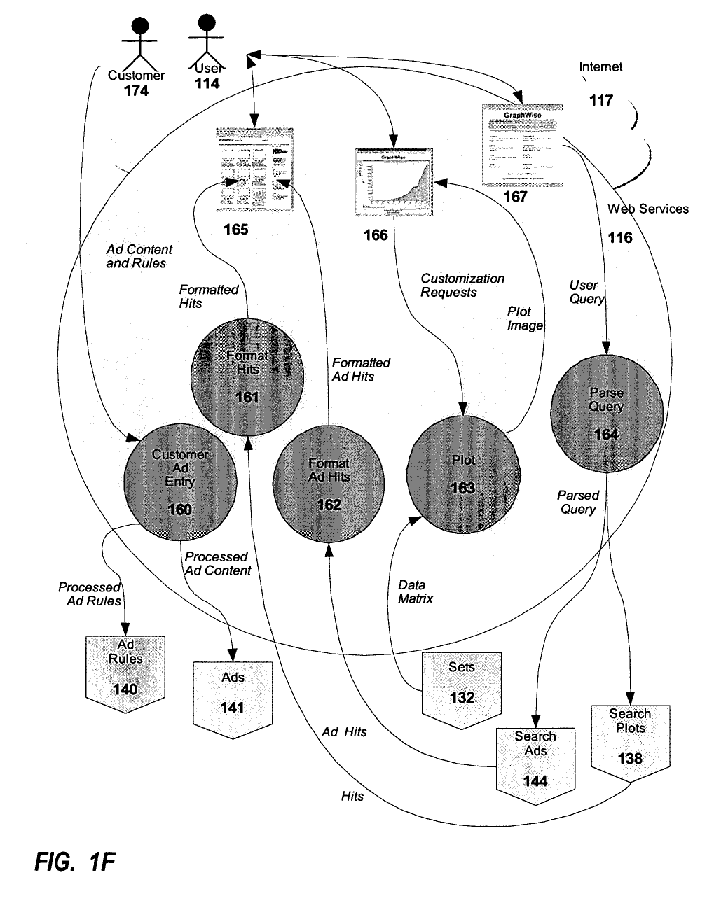

Referring to the drawings in detail, wherein like numerals indicate like elements throughout, there is shown in FIG. 1A a broad overview of the data and processes of an embodiment of the present invention. The depicted system architecture consists of a number of interoperating software programs, potentially distributed across a varying number of computer servers. There are three fundamental categories in which the software for the system operates: (111) Input Services, (115) Repository Services and (116) Web Services. In various embodiments of the invention, each of these service subsystems may be supported by one or more physical computer servers.

The Input Services component 111 locates tabular data on the Internet and downloads the selected files. It also manipulates these downloaded files until they are conformant with a consistent tabular flat file format within a conventional (112) File System, and are thus ready for importing into the system (utilizing the Repository Services component 115). The Input Services component include a daemon application that checks for updates on a regular basis (as specified for each data set), and downloads updated versions of files for re-incorporation into the system. In one embodiment of the invention, the process of screening input and the creation of conformance parameters is assisted by database administrators or Researchers 113 as illustrated in FIG. 1A.

In one embodiment of the invention, the Repository Services subsystem 115 is contained within a relational database management system (RDBMS) consisting of normalized tables and programmed, server side support functions. The Repository Service subsystem 115 stores the data in a uniform format; associates searchable, salience-ranked text with data plots; and provides scored relevance query support to the Web Services component 116.

The Web Services subsystem 116 receives requests from web Users 114; formats those requests as queries and selections; and relays them to the Repository Services, which responds with relevance-scored query results (“hits”), as well as ad results and plotting data. This information is formatted by processes within the Web Services component 116 and presented over the Internet 117 to the User 114 for further interaction.

Each of the processes within the three Services components will now be described in greater detail.

Input Services 111

FIG. 1B provides a detailed decomposition of the processes and data flows within Input Services component 111 in accordance with one embodiment of the invention. Researchers 113 locate tabular data on the Internet, selecting data Sources and Sets for downloading. In one embodiment of the invention, researchers review various sources of public information, such as databases of government statistics, to recognize files containing tabular data appropriate for downloading. As used herein “Sources” are essentially web site pages that contain one or more files that represent Sets of data. A data “Set” may consist of one or more files in tabular form. These tabular data sources and sets are retrieved 120 and stored into a File System hierarchy 112 in their original (“raw”) form.

FIG. 1B also depicts a Create Conformance Scripts component 121, wherein in one embodiment of the invention Researchers 113 create scripts to transform the raw files into conformed data files. This transforming process removes any unnecessary or redundant information and creates conformed data files having a uniform syntax. Whenever possible, these scripts are created with the aide of existing scripts based on processing data in generalized table patterns. These scripts are stored in the File System hierarchy 112, along with their related Sources and Sets.

FIG. 1B further depicts a Run Conformance Scripts component 122. Here, the system executes conformance scripts for Source and Set data stored in the File System hierarchy 112, generating conformant Set and Source files that are ready for importing into the Repository Services subsystem 115 via an Import Conformant Sets and Sources Component 135.

In the depicted embodiment, the Input Services component 111 also comprises a process to Create Plot Specs 123. This process creates a set of Plot Specifications for each data Set for comprehensive exploitation into Plots. As used herein, “Plots” are views into data sets that may be presented graphically. Accordingly, data in a group of sets may be organized into multiple data plots, viewed from different perspectives, containing different portions (“slices”) of data.

Various examples of Sets and Plot Specs will now be discussed. As noted above, the present invention processes data that is in a matrix format. Each such data matrix gets stored as a Set. For each Set, many separate plot specifications can be created, regardless of the original arrangement of the tabular data. As illustrated in the examples below, the data can be in the simplest form, as in Table 1; in multiple columns as in Table 2; or in a more complicated form as in Table 3. Plot specifications define a template by which graphs can be later created by the system. Each Plot will consist of one or more row/column slices taken from the overall data set, each slice serving alternatively as overall plot label, axes labels, and data values. Tables 1 and 2 permit automatic generation of all such row/column combinations. In one embodiment of the invention, this automatic generation feature is capable of merging related data at the time of creating the plot specification. That is, data is combined within a Set to form a larger Set. Table 2 illustrates this feature wherein the original Set depicted perceived news partisanship of the three major networks, ABC, NBC and CBS. The invention had derived a fourth row (a total) to thereby create a larger Set.

It should be noted that more complex data, such as that appearing in Table 3, require the aid of the Researcher 113 to generate sets of plot specifications.

TABLE 1

| Date | Value |
|---|---|
| 06/30/1922 | 0.111 |
| 06/30/1923 | 0.1 |
| 06/30/1924 | 0.094 |
| 06/30/1925 | 0.095 |

TABLE 2

| Network | Republican | Democrat | 3^{rd} Party/Independent |
|---|---|---|---|
| ABC | 73 | 27 | 0.7 |
| CBS | 76 | 23 | 1.2 |
| NBC | 75 | 25 | 0.2 |
| All 3 | 75 | 24 | 1 |

TABLE 3
Table 010. Infant Mortality Rates (deaths/1,000 live births) & Life Exp at Birth, by Sex

| | | | [C3] | | | [C6] | [C7] | [C8] |
|---|---|---|---|---|---|---|---|---|
| | | | IMR | [C4] | [C5] | Life | Life | Life |
| | [C1] | [C2] | both | IMR | IMR | Expectancy | Expectancy | Expectancy |
| [R1] | Country | Year | sexes | male | female | both sexes | Male | Female |
| [R2] | Afghanistan | 1978- | 182.00 | 188.00 | 175.00 | 40.90 | 41.80 | 40.10 |
| | | 79 | | | | | | |
| [R3] | Afghanistan | 1979 | 191.45 | 198.11 | 184.45 | 38.78 | 38.51 | 39.06 |
| [R4] | Afghanistan | 1980 | 191.87 | 198.53 | 184.87 | 38.73 | 38.46 | 39.00 |
| | Albania | 1963 | 90.59 | 88.76 | 92.56 | (NA) | (NA) | (NA) |
| | Albania | 1963- | (NA) | (NA) | (NA) | 64.90 | 63.70 | 66.00 |
| | | 64 | | | | | | |
| | Albania | 1964 | 81.53 | 76.76 | 86.58 | (NA) | (NA) | (NA) |

A specific example of the generation of plot specs is illustrated below with respect to Table 3. In particular, a rough set of specs for selecting a few different types of graph plots from Table 3 are listed. For the sake of illustrating this example, columns and rows labels (in brackets) are depicted. In fact, such labels are not part of the stored table or Set.

Sample Set of Plot Specs

| Plot Label | X-Labels | Y-Values | Types | Units |
|---|---|---|---|---|
| Rn:C1..C2 | R1:C3..C5 | Rn:C3..C5 | Bar | People |
| Rn:C1,R1:C3 | Rn:C2 | Rn:C3 | Line,Bar,Scatter | People |
| Rn:C1..C2 | R1:C4..C5 | Rn:C4..C5 | Pie,Bar | People |
| R1:C3,Rn:C2 | Rn:C1 | Rn:C3 | Pie,Bar | People |

Where: n is an integer, 1<n≦N, N being the total number of rows in the data matrix of Table 3 above; R1 represents column headings; Rn represents row data; and Cm, m an integer, represents column data.

As illustrated, each Plot consists of one or more row/column slices taken from the overall data set, each slice serving alternatively as overall plot label, axes labels, and data values. By way of example, the first entry of the “Plot Label” column, Rn:C1..C2, would generate a plot label consisting of a country name (C1) and a year (C2). In the case of n=2 this label would be “Afghanistan 1978-1979”. Continuing with the first example (i.e., the first row) of the “X-labels” column, those X-axis labels would be “IMR both sexes” [C3], “IMR Male” [C4], and “IMR female” [C5] for any value of n. The corresponding entries for first “Y-Values” entry, Rn:C3..C5, would be “182.00”, “188.00” and “175.00” for n=2. In this manner the template represented by the first row of the Sample Set of Plot Specs is capable of generating N-1 separate bar graphs depicting the IMR data for the selected n value. Other examples of plot specs for line, bar, scatter and pie plots are also depicted in the Sample Set of Plot Specs.

As illustrated in FIG. 1B, the determined Plot Specs are passed to the Repository Services subsystem 115 for use in a manner described further below. Further embodiments of the invention support cross table joins, which would support table elements that reference other lookup tables (and data from normalized database tables).

A further process within the Input Services component is performed by a Check for and Retrieve Updates component 124 wherein an automated process reads the frequency and addressing parameters associated with Sets to determine if the modification date and/or size of the file has changed since it was last loaded. If so, the file is downloaded and prepared for incorporation, then updated in the Data Repository. The same update check is performed for Source pages; that is, if pages have changed, the latest revision is downloaded to the File System and the processed pages updated in the Repository. The modification dates are updated in the Repository. Missing Source and Sets and corrupted sets are flagged for intervention by Researchers 113 who may decide to retain or remove the system copies.

Repository Services

The Repository Services subsystem 115 is the query/response core of the system. Repository Services support the association of salience-ranked texts with individual data Plots and the relevance-scored querying of those Plots. A parallel salience ranking and relevance scoring of commercial advertisements is supported, along with plot trend analysis and subsequent rule based selection of ads. FIGS. 1C, 1D and 1E detail the three conceptually distinct relational databases, a Plots Database 115A, an Ads Database 115B, and a Query Cache Database 115C that are contained in the Repository Services subsystem 115. These databases incorporate data storage tables and pre-programmed functions. Each of these will now be discussed in greater detail.

In the embodiment of the invention illustrated in FIG. 1C, the Plots Database component 115A stores all data, parameters and functions relevant to Sources, Sets and Plots. It responds to the Input Services 111 for populating its portion of the Repository 115, and to Web Services 116 for query and plotting requests.

As illustrated in FIG. 1C, in performing these functions, the Plots Database 115A component utilizes Attribute Lookup Tables 130. A number of search related parameters are associated with each Plot in the system. These parameters are tracked by unique identifiers to enforce consistency and improve performance. Source, Set and Plot entries reference elements in these “lookup” tables. This use of identifiers also enables the system to establish aliases (e.g., “United States”/“USA”/“Uncle Sam”/etc.) to aid in conducting comprehensive searches in response to submitted queries).

Also depicted is a Sources table 131 which stores data about the original source, including Internet addressing references. The table below gives exemplary entries of such a table. Also depicted below are tables for Sets and Plots as well. Each of these tables list various attributes and their corresponding weights. These table entries are presented for the purpose of illustrating the invention and are not meant too be a comprehensive listing of all such attributes. By way of example, in a further embodiment of the invention, the Source Table contains schedule information for performing updates. Moreover, in various embodiments of the invention, it is envisioned that actual attributes and their weights would be updated regularly over time.

Source

| Attribute | Description | Weight |
|---|---|---|
| Title | The title of the data source. For example, “University of | 0.4 |
| | East Anglia, Climatology Department Data Publications”. | |
| Description | A few short paragraphs describing the source, often | 0.2 |
| | distilled by the DBA from the web site page. | |
| Language | The (human) language in which the data is stored. | N/A |
| Source Type | The type of the source: Government, Business, | 1, iff |
| | Organization or Education, typically corresponding to | specified |
| | .gov, .com, .org/.net, and .edu. | as |
| | | criterion |
| | | by user |
| Source Location | The geographic location of the source. For example, | 0.1 |
| | “United States”, if published by the US government. | |
| About Location | The geographic location of the data. For example, | 0.1 |
| | “Africa” if the data is about HIV/AIDS in Africa, or “World” | |
| | if it is about energy consumption for multiple countries | |
| | around the world. | |
| URL | The web location of the source. For example, us.bls.gov. | 0.1 |

FIG. 1C further illustrates a Sets table 132 which stores the tabular data for each set, along with other attributes of the set. The following table is illustrative of the type of entries stored in such a table.

Sets Table

| Attribute | Description | Weight |
|---|---|---|
| Title Base | The base title of the data set. For example, “Wheat | 1 |
| | Imports”. This base is used in auto-generating the titles for | |
| | all plots. | |
| Description | A paragraph or two defining the data set, often taken from | 0.4 |
| | the data set headings themselves. | |
| Subject | The main subject of the data. For example, “Wheat”, in a set | 1 |
| | about wheat imports. | |
| Location | The geographic location of the entire data set. For example, | 1 |
| | “Africa” in a set about oil production levels in Africa, which | |
| | might be from a Source about oil production from continents | |
| | around the world. | |
| URL | The web path to the data set, if separate from its source | N/A |
| | page. | |
| Data Matrix | A multi-dimensional array of tabular data. This data is used | N/A |
| | to provide multiple Plot windows. It contains both labels and | |
| | data values. | |
| Minimum | Minimum applicable date to data range. The same as the | 1 |
| Date | Maximum Date for data series that are non-temporal. | |
| Maximum | Maximum applicable date to data range. The same as the | 1 |
| Date | Minimum Date for data series that are non-temporal. | |

A further feature of FIG. 1C is the Plots table 133 which stores plottable views into the parent Sets table 132. These plottable views consist of sets of row and column slices of that data. This table also contains attributes specific to the plot, such as geographic location, subject matter, and category membership. Further, text used in the description of the data plots is stored in vectors of stemmed words, each with an indication of its location in the text and its associated weight. Queries for user hits scan these text vectors. The following is an example of such a Plots table:

Plots Table

| Title | The title of the plot. For example, “Wheat Imports, 1990”. | 1 |
|---|---|---|
| Subject | The main subject of the data. For example, “Wheat”, in a set | 1 |
| | about wheat imports. | |
| Type | The type of data in the set, currently one of: time series, | N/A |
| | geospatial or population based. | |
| Label | The orientation of the window into the Set Data Matrix; either | N/A |
| Orientation | Row or Column. | |
| Data Indexes | A map of indexes that define the window of this Plot into the | N/A |
| | Data Matrix of the parent Set. | |
| Resolution | Level of temporal resolution (e.g., daily, weekly, monthly, | 1, iff specified as |
| | yearly, bi-annually), or “Itemized” for non-temporal data. | search criterion |
| Location | The specific geographic location of the data in this plot. For | 1 |
| | example, “Kenya” in a plot derived from a set of oil production | |
| | levels in from countries and continents around the world. | |
| Plot Types | The set of recommended ways of visualizing the data, | 1, iff specified as |
| | currently including: bar, line, area, scatter, pie, vector, and | search criterion |
| | map. Also contains an indicator if the set is a composite | |
| | parent consisting of multiple children data sets (e.g., poll | |
| | results in which each candidate's results are a separate set). | |
| Units Type | The units of measurement for the data. For example, “metric | 0.4 |
| | tons” for wheat imports, or “USD” for US dollar indexes. | |
| Units Multiplier | Multiplier for units with large values (e.g., 1,000,000) | N/A |
| Units Name | The actual display name for the units, which may differ from | 0.5, iff specified as |
| | the associated lookup ID of the Units Type | search criterion |
| Categories | Hierarchical category assignments for the data. Data sets | 1 |
| | may belong to several categories. For example, imports of | |
| | hydrocarbons might relate both to “Business” and | |
| | “Environment”. | |
| X Axis Title | Title for the X axis, if any. | 0.2 |
| Y Axis Title | Title for the Y axis, if any. | 0.2 |
| Search Vectors | Indexed text derived from the various attributes of the Plot, its | Composite Set of |
| | parent Set and Source. Weights of these attributes are | Weights of All |
| | combined within these vectors. | Source/Set/Plot |
| | | Attributes |

The Plot Specs table 134 contains a list of specifications for each data set that is used by the system to generate automatically a varying number of Plot views of the set data matrix.

As illustrated in FIG. 1C, in operation the process labeled Import Conformant Sets and Sources 135 loads files that have been prepared within the File System hierarchy 112, populating primarily the Sources 131 and Sets tables 132. Other Tables are incidentally updated as information regarding geographic locations, subject matter and categories are discovered while loading Sources and Sets. The Plots table 136 is populated automatically. The algorithm within this process reads relevant specifications from the Plot Specs table and generates actual plot views. Each specification may result in the instantiation of one or many Plots.

The system has the ability to gain self knowledge and extend its Sets and Plots repository through a self-examination contained in the Generate Self Analysis Plots component 137. This process employs algorithms that create Plots of meta-data regarding the size and shape of the repository and the interactions with it. Thus, for example, a “Top 10 Categories” Plot is created by querying the database at any given time. Queries of the repository over time generate similar potential Plots.

The process labeled Search Plots 138 in FIG. 1C receives query requests from Web Services and responds with search and ad hits, plot information and ad content. Information about searches is stored in the Query DB portion of the Repository, to be used both as a performance cache and as a source of self-knowledge.

FIG. 1D illustrates various tables and processes relating to the Ads database 115B and accordingly, management of various advertisement display functions. It should be noted that the Ads Database 115B may be instantiated across one or more servers to facilitate performance. It stores information input by Customer Users 114 as well as usage data tracked automatically by various system processes.

The Ad Rules table 140 provides a knowledge base from which advertisement recommendations can be made. In one embodiment of the invention, these recommendations are based on plot trend analysis, in which case the rules refer to categories and subject matter of Plots and ads to make a selection based on trends within those types of Plots. In further embodiments, rules may contain weights for applicability, both in response to the scale of trends and in relation to the textual relevance of associated queries.

Thus, for example, a rule might suggest that any plots demonstrating an increase of more than 10% in the price of gasoline would result in a selection of ads relating to hybrid cars, additionally favoring these ads (through weighting) over other ads that may have more textual relevance.

The Ads table 141 stores the content of advertisements, including relevant images and text, as provided by customer users or sponsors of the system. The Ad Hits table 142 keeps a record of all ad impressions (i.e., the number of times particular ads are displayed to one or more users) and user clicks, along with web client information collected about the user.

In operation, the Analyze trends component 143 examines the current plot for distinct trends and compares any identified trend against the rules contained in the Ad Rules table 140. The selected ads, or Ad Hits, are used as input to the Search Ads component 144. The Search Ads component 144 merges the results of query relevance and trend analysis relevance to respond to user 114 queries with not just requested data, but also with highly relevant ads supplied by the customer users. In a further embodiment of the invention, weighted results from both relevance and trend analysis are merged by mathematically combining their relative weight factors.

FIG. 1E illustrates the Query Cache Database 115C component of the Repository Services 115. As with other components of the Repository Services 115, the Query Cache Database 115C may be embodied on one or multiple servers, depending on performance requirements. It provides the first recourse to the Search Plots process, allowing it to retrieve previous search results to save repeating costly, identical searches of the system.

The Query Cache Database 115C comprises a Query Hits table 150. This table tracks the number of times a particular query is issued, along with the collected information about the user web client (browser). This table is used as input for the Generate Self Analysis Plots process 137 discussed above. The Query Cache Database 115C also contains a Queries table 151. In one embodiment of the invention this table primarily serves as a cache of unique queries of the system. To improve performance, this table stores instances of Formatted Queries and their results. The query caches N records at a time (in one embodiment, 100 records), providing instantaneous responses for users paging through hits.

Web Services

Web Services 116 provide an interface between Users 114 and the Repository Services 115. In various embodiments of the invention, some of the services may be provided by system databases, while others are provided by an extended web server application. In the embodiment depicted in FIG. 1F, all services are provided through programs executed by an extended web server.

One of these depicted programs is identified in FIG. 1F as a Customer Ad Entry component 160. This component, receiving input from advertising customers 174, is used in populating and updating the Ad Rules 140 and Ads tables 141. In one embodiment of the invention, Ad Rules are entered in web forms and transformed into knowledge base representation for system use. Ad content and images are uploaded via web forms and stored within the Ads Database 115B portion of the Repository 115.

FIG. 1F further depicts a Format Hits component 161 whereby hits received from the Search Plots process 138 are formatted for web display and interaction. Hits include relevance scores, Plot information, relevant portions of the Set data matrix and thumbnail images. Similarly, Ad Hits received from the Search Ads process 144 are formatted by a Format Ad Hits component 162 for web display and interaction. Ad Hits contain title, content, image and web linking information.

The Web Services system depicted in FIG. 1F further illustrates a Plot component 163 wherein data received from the Sets component 132 is formatted according to one or more selected Plots. If more than one Plot is selected, data may be merged. Merging of plots potentially entails the “rolling up” of data to common formats and units along the axes and the construction of composite titles. Thus, for example, if a monthly time series plot of cotton production in pounds is plotted along with a year-based time series graph of wheat production in tons, the units are merged to tons and the time rolled up into years. In situations in which the requested merger cannot be performed (e.g., incompatible units), an additional embodiment of the invention would respond by graying the background of the graph and/or providing some other visual means of so informing the user.

A Parse Query component 164 parses User 114 entered queries, formatting the results for use by the Search Ads 144 and Search Plots processes 138 (both of which processes having been discussed above).

As illustrated in FIG. 1F, the Web Services 116 further comprises generating various displays for transmission over the Internet 117. These include Hits Displays 165, Plot Displays 166 and Query Displays 167. While these display elements will be discussed in greater detail below, a summary of their functions will provided at this time. Hit Displays 165 displays Plot and Ad Hits results in a variety of potential ways to Users 114. Plot Displays 166 comprise graphs and web form elements for supporting customization interactions. These form elements serve as input to the Plot component 163, allowing Users to iteratively refine display parameters. Query displays 167 support the entry of queries in the form of User selections (clicks) and text entries which are then turned over to the Parse Query module 164 for subsequent relay to the Repository Services 115 for response. Query displays may have a number of embodiments.

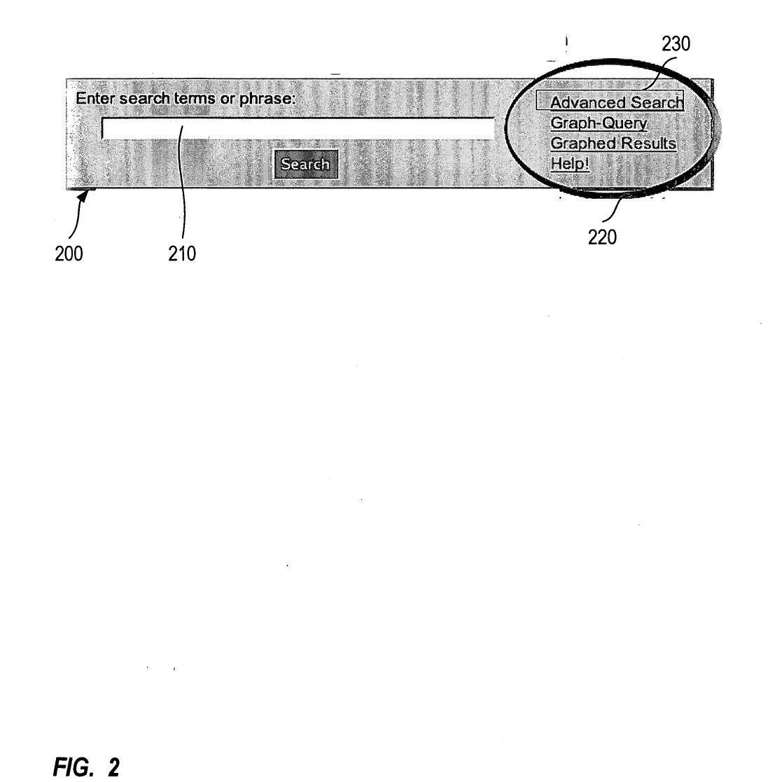

FIG. 2 depicts a screen shot of an exemplary query display that is provided to the user according to one embodiment of the invention. A window 200 is displayed in which search terms or phrases can be entered 210 and various initial output options 220 can be selected.

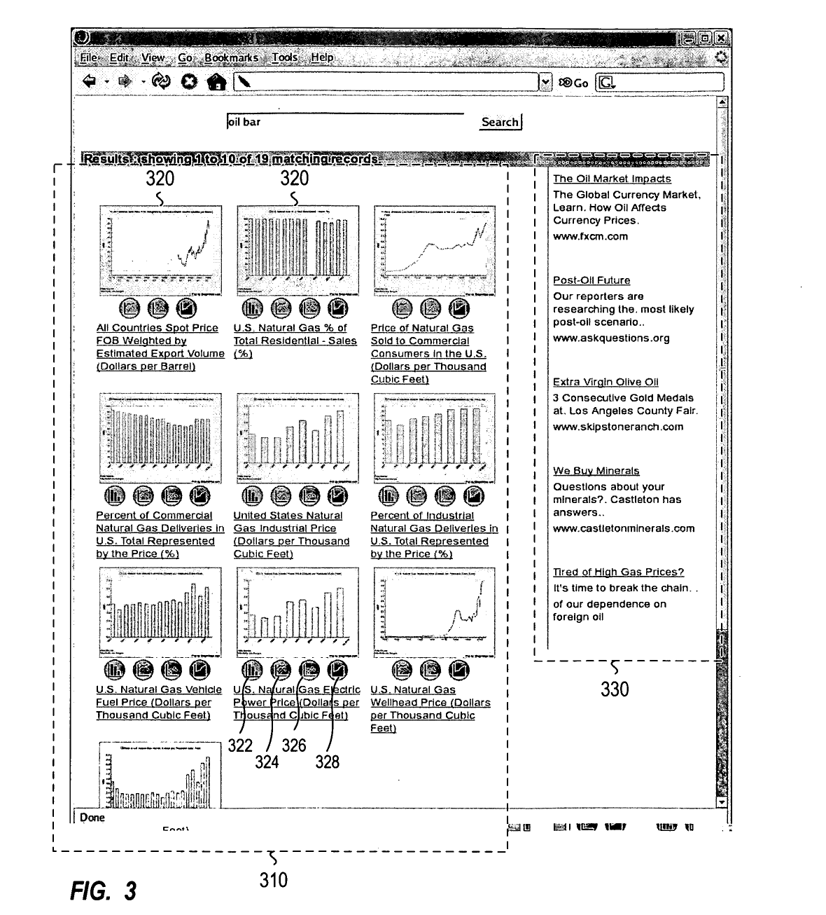

As noted above, once the query is submitted, the system then searches and determines scored hits which are plotted and collated with relevant advertisements and returned to the user via a display 165. In a further embodiment, the system summons a query process that compares the search terms against every Source/Set/Plot combination in the plots database 115A and returns the top N hits and the total number of matching items with a rank above a certain threshold. By way of example, entry of the phrase “oil bar” as the search phrase and selection of “Graphed Results” in the window 200 yields search results that are displayed in FIG. 3.

FIG. 3 is a screen shot which displays in section 310 the results of the search as thumbnail graphs 320. In the embodiment depicted, the first 10 results of the search are displayed, with a “<<Previous Next>>” navigation bar (not illustrated) provided thereby permitting access to additional search results. Once a user receives a response to his search query, various embodiments of the invention permit him to click on the associated data source link to be taken to the original web site and/or he may choose to quickly plot the data by selecting one of the associated graphing icon links. Thus, for each thumbnail 320 provided, buttons below the graph show available alternative plot options. By way of example, clicking on button 322 yields a detailed bar graph of the displayed data. Similarly, buttons 324, 326 and 328 yield corresponding line, scatter and area graphs, respectively.

FIG. 3 also contains a section 330 which provides various links to Web sites containing related subject matter. In one embodiment of the invention, this area can be used to provide targeted advertisements to the user based on his current search, previous search(es) or other user determined indicia. This aspect of the invention is further described below.

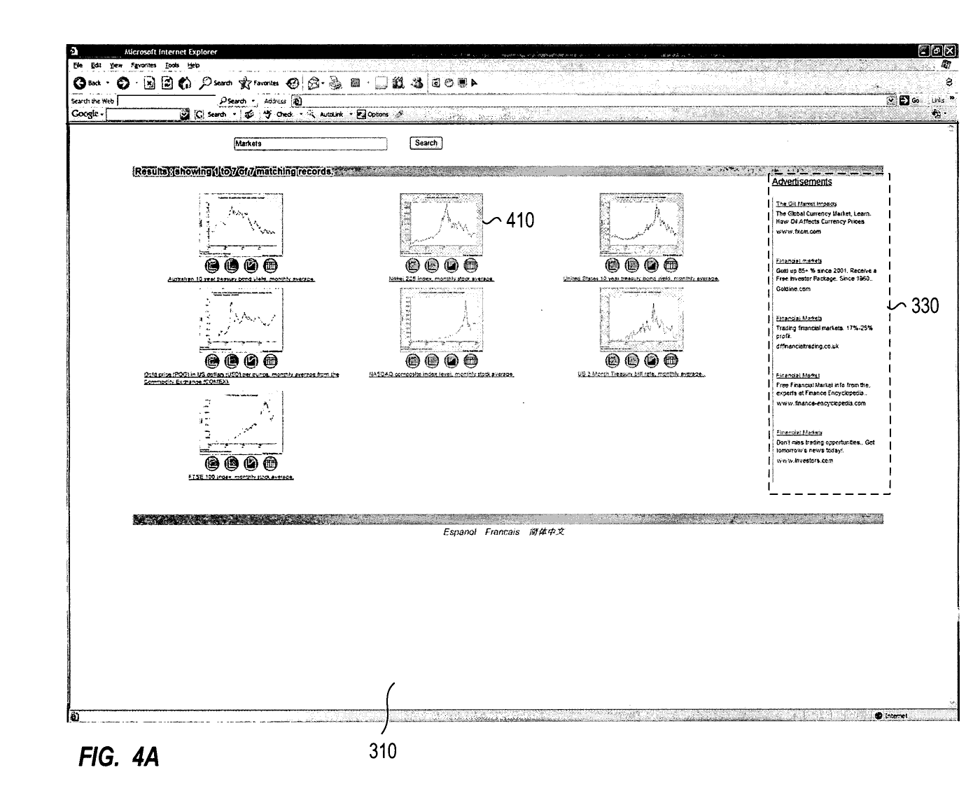

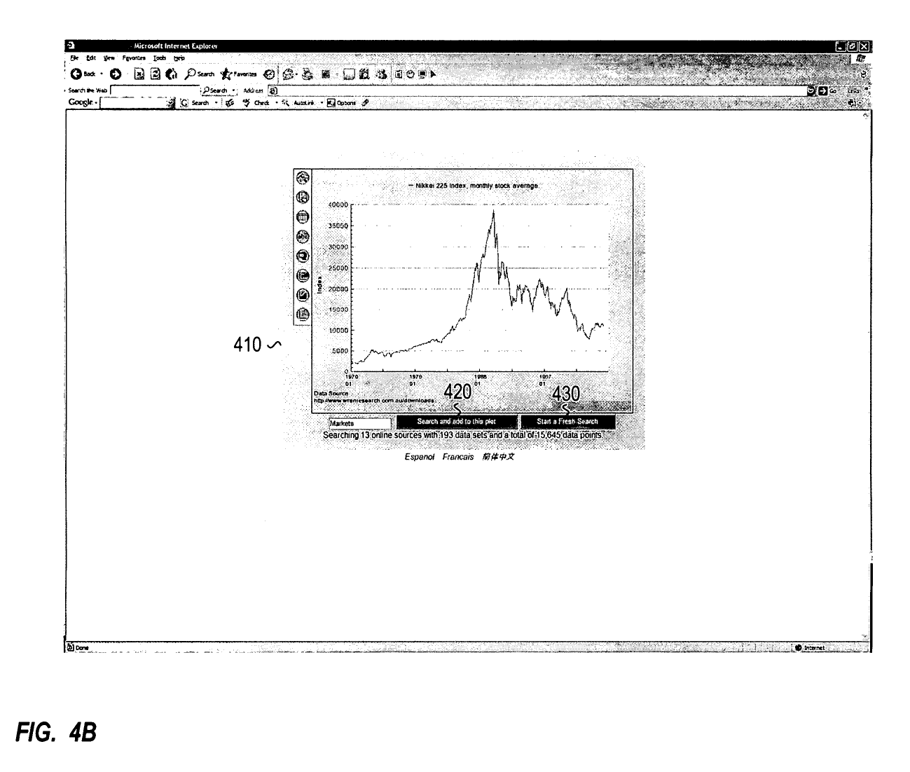

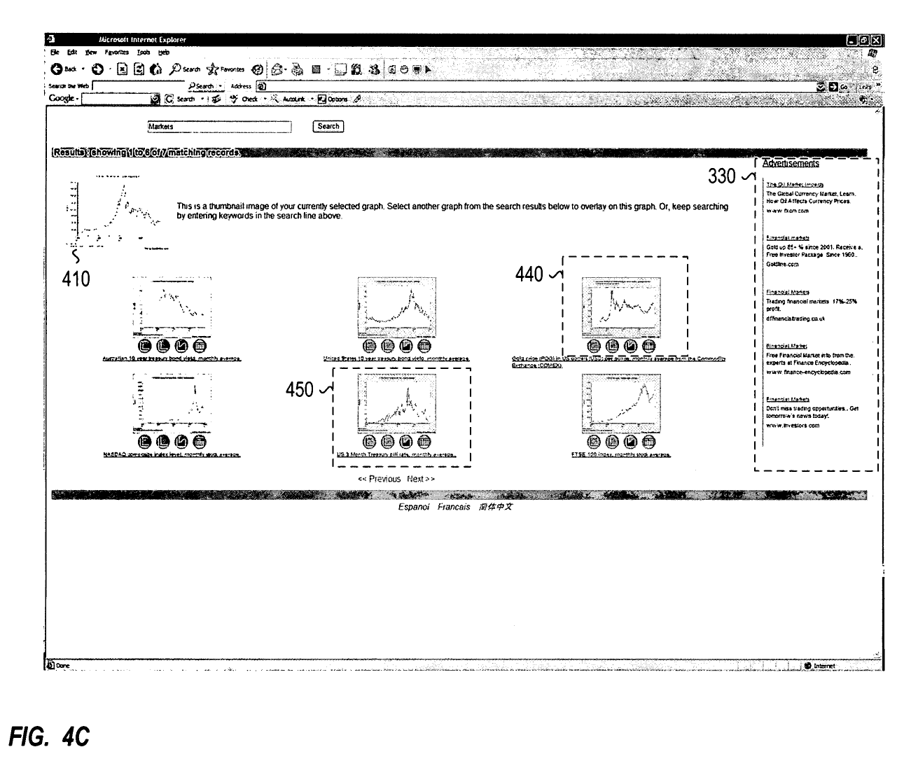

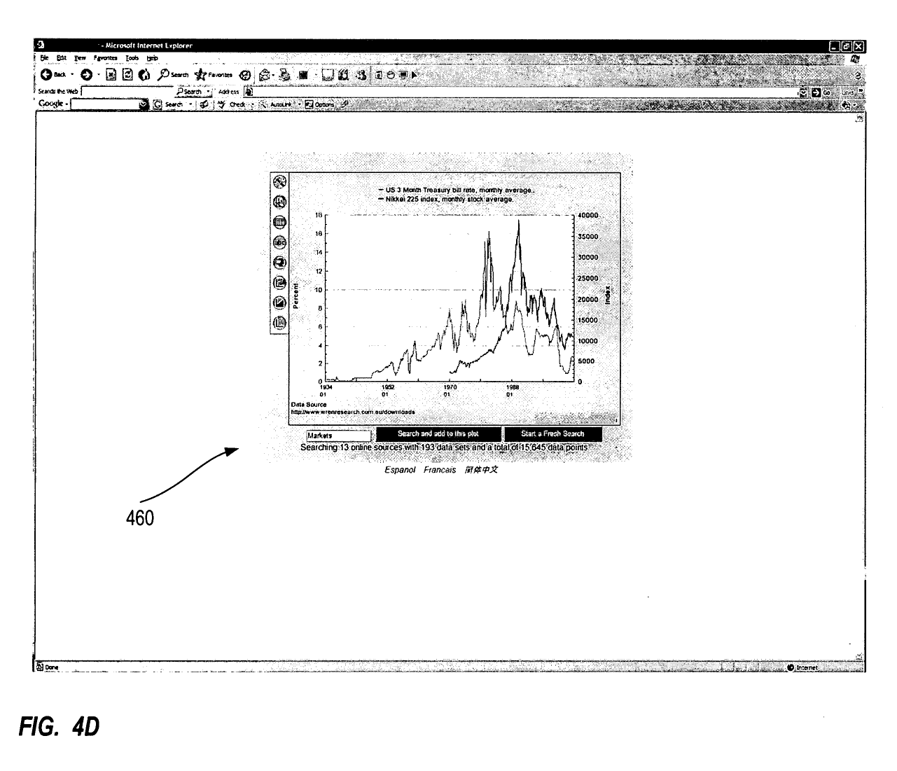

FIGS. 4A-D are screen shots depicting a further embodiment of the invention wherein a secondary search is being conducted. FIG. 4A depicts an initial search result, similar to the search result depicted in FIG. 3. FIG. 4B illustrates the result of clicking on graph 410 of the displayed thumbnails. FIG. 4B provides the user options to “Search and add to this plot” 420 or “Start a Fresh Search” 430. Selection of button 420 yields the screen shot depicted in FIG. 4C wherein graph 410 appears at the top of the page with instructions to the user that he can overlay any of the graphs appearing below onto graph 410. By way of example, clicking on graph 450 results in the invention returning the screen shot depicted in FIG. 4D wherein the graph 460 consists of the combination of the data of graph 410 and graph 450. Although not illustrated, the invention permits the above described steps to be repeated so that, for instance, the data of graph 440 (FIG. 4C) can be added to the graph 450.

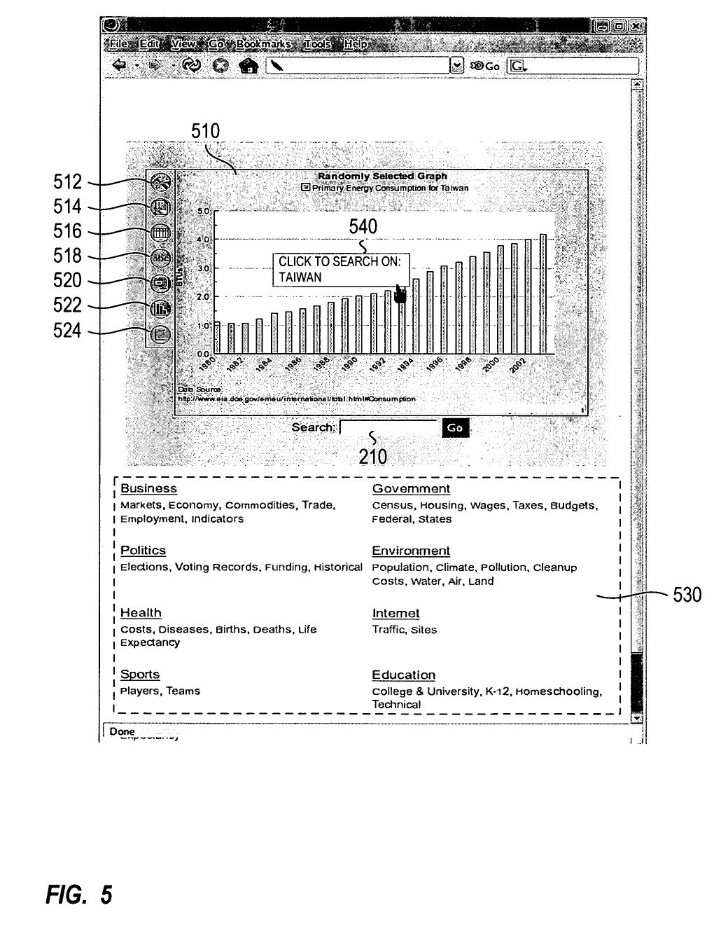

FIG. 5 depicts a screen shot of an exemplary front page 400 of the invention's Web site according to a further embodiment. In this example a “Randomly Selected Graph” (in particular, a graph of the “Primary Energy Consumption for Taiwan” for the years 1980-2002) appears in section 510 of the window. The particular graph displayed may be determined randomly or may be a system selected “Graph of the Day,” perhaps related to a prominent current news event. As in the previously described embodiments, a search window 210 is provided for the user to commence his search.

FIG. 5 also depicts various control buttons that are related to functions provided by this embodiment of the invention. In particular, button 512 launches a utility program that permits the user to customize the graphed data. This customization includes, but is not limited to, adjustments to the graph's vertical and horizontal scales, adjustments to color and fill, modification of the graph title; addition of a watermark; adjustments to the size of graph and/or its margins; etc. Button 514 enables the user to download the data depicted on the graph to a spreadsheet, while button 516 permits the user to view the data in tabular form. Button 518 results in tab-delimited data of the graph being displayed in plain text. Button 520 enables the user to download a compressed file containing this tab delimited data. Buttons 522 and 524 provide the same alternative types of graph displays (when conducive to the data) that were discussed earlier with respect to FIG. 3.

FIG. 5 also provides a section 530 of the display which contains various subject matter topics which when activated, launch graphs related to the particular item selected.

A further feature of the invention is illustrated in FIG. 5 wherein hovering of the screen cursor above a section of the depicted graph data causes a window to appear 540 which permits the use to click to perform an additional search related to that data. In particular, placing the cursor over the section of the graph depicting 1994 and then clicking (with or without the hovering window 540 appearing), would result in a subsequent search of energy consumption in Taiwan in 1994. This provides the user with an efficient means to do a followup search of the data originally presented. Thus, in this example, clicking on the 1994 bar may yield (depending on the hits returned by the subsequent search) further graphs which breakdown the types of energy used in Taiwan in 1994, the energy use by Taiwanese Provinces, Taiwan's energy use by month.

This feature of performing a query by clicking on a portion of displayed data is applicable to various types of displays (pie slices, bars, points on scatter graphs, map regions). Further, where legends containing data are part of the display, the feature is implemented by clicking on legend items themselves.

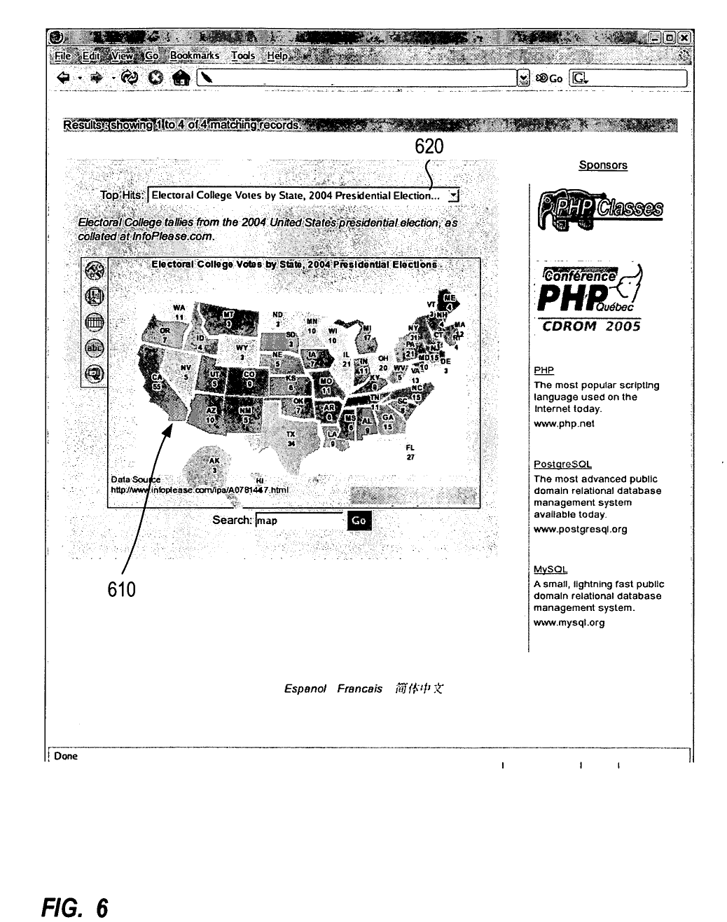

FIG. 6 illustrates additional features of the present invention in which a query result is portrayed as a map 610. A pulldown menu 620 permits the user to leaf through various additional related map data that is available in the database.

In various embodiments of the invention, the data are plotted on a graph that is scaled automatically. When two or more plots share a graph (e.g. as in FIG. 4D), the system automatically compensates for differences in scale, data ranges, granularity and time ranges whenever possible. Thus, given two sets of data—one with a Y range from 10 to 100, granularity of one month, and an X range of June-1970 through June-1980; and another with a Y range from 500,000 to 1,000,000, a granularity of one year, and an X range from 1950 to 2000; the system will generate a plot with two Y axes, an X range of 1950 to 2000, and a granularity of one year.

Returning to FIG. 2, it should be noted that the query language of the present invention is not limited to simple phrases. More advance searches are supported by the invention, primarily through the “Advanced Search” request 230. The result of this request is a series of tagged phrases. By way of example, the query “units:metric tons & wheat” would search for data sets in which wheat is measured in metric tons (and possibly analogous units of weight). The query “−units:metric tons & wheat” would search for data in which wheat is specifically not measured in metric tons. Adding a plus sign (+) to a phrase forces that particular phrase to be present in any results.

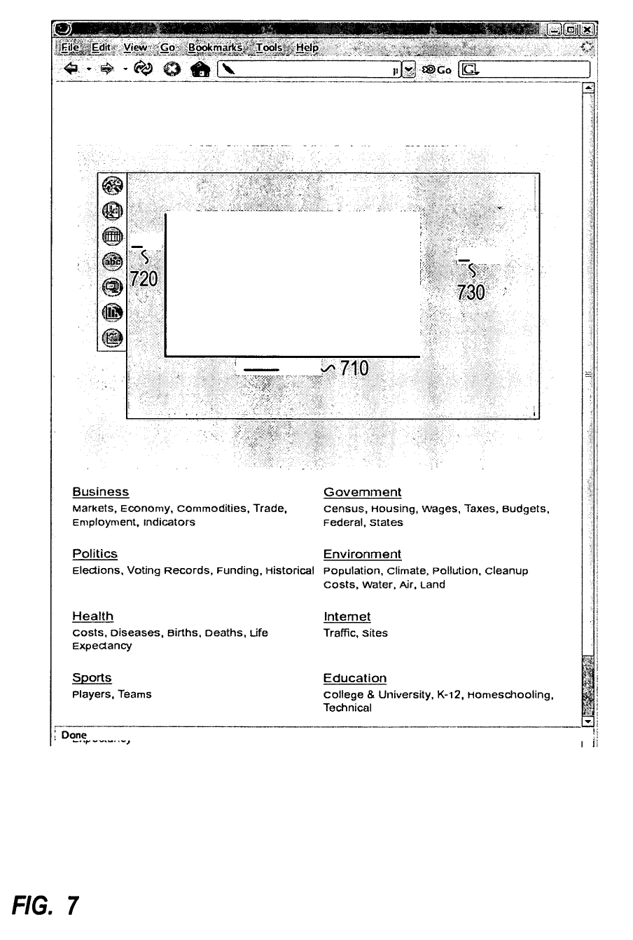

A further embodiment of the invention relating to search querying is illustrated FIG. 7. This exemplary screen shot depicts a “blank” graph which is presented to a user. The user can then input both the X and Y axis “values” (items 710 and 720, respectively) and then trigger the corresponding search. By way of example, a user may request U.S. wheat export tonnage on the Y axis and calendar years on the X axis.

Additional embodiments permit a second “blank” graph to be presented. The user can again input desired values to generate a second graph and then combine both graphs to create a single graphical representation. In still further embodiments of the invention, a third query window 730 is presented to the user. In one such embodiment this permits the user to enter a second Y axis value. The resulting graph would automatically combine two graphs by depicting both sets of Y values against a common X axis (wherever the data is compatible to do so). In another use of window 730, the value entered therein would be a Z axis “value,” thereby generating a three-dimensional graph result.

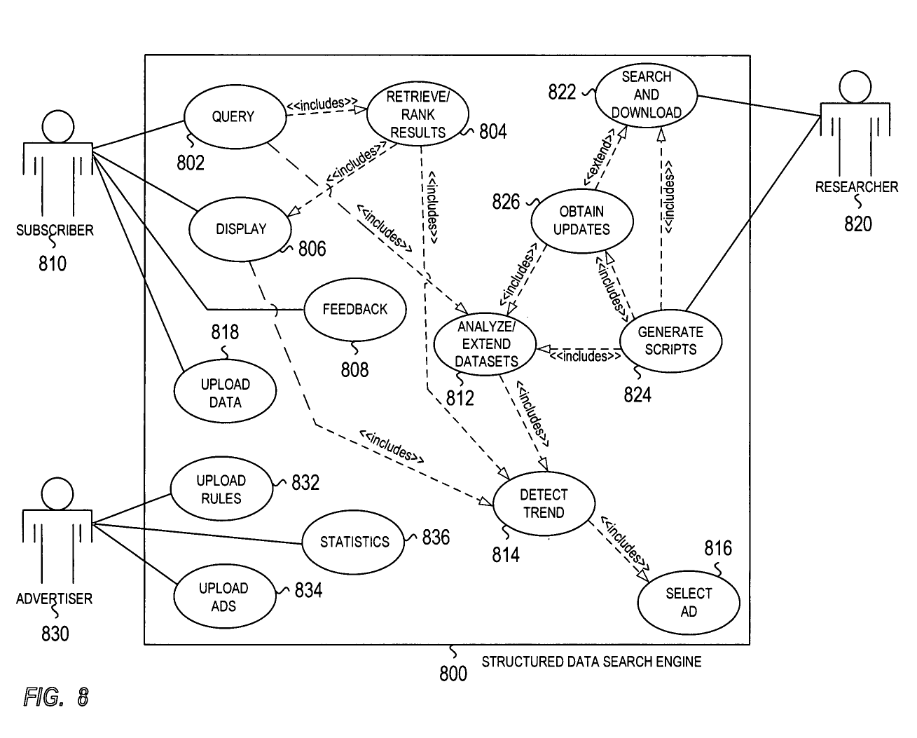

Various aspects of the invention will now be discussed with reference to FIG. 8. This figure illustrates a Unified Modeling Language (“UML”) use-case diagram for the structured data search engine 800 and associated actors in accordance with the present method and system. UML can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the present method and system, but do not constrain its implementation to any particular hardware or software embodiments. Unless otherwise noted, the notation used with respect to the UML diagrams contained herein is consistent with the UML 2.0 specification or variants thereof and is understood by those skilled in the art.

The structured data search engine system 800 comprises a query use case 802, a retrieve/rank results use case 804, a display use case 806, a feedback use case 808, an upload data use case 810, an analyze/extend datasets use case 812, a detect trend use case 814, and a select ad use case 816.

A user of the system, identified as a subscriber 810 in FIG. 8, uses the system 800 to attain a displayed result in response to his query. The method employed by the system comprising the following steps:

(a) receiving a query 802 entered by a user; and,

(b) locating a plurality of data sets wherein at least one dimension of each of said plurality of data sets corresponds to at least a portion of said query string, accessing and ranking 804 at least a subset of said plurality of data sets, and creating a display 806 of the results.

As described above, the system further permits the subscriber 810 to vary the manner in which the data is presented. This feedback information 808, as well as the search results themselves 804, is utilized by the system to detect trends 814. Such trends are used for purposes such as selecting appropriate advertisements 816 to be included in the display as well as for formatting the graph portion of the display in a manner that in the past has been preferred by one or more users.

The analyze/extend datasets use case 812 depicted in FIG. 8 looks at the source, Sets and Plots database 115A and derives data sets via self-learning results. In one embodiment, an auto-merging process is periodically invoked whereby various existing data sets are merged and/or combined. The analyze/extend datasets use case 812 also analyzes query information to derive data sets based on this information. This information permits graphs relating to previous system inquiries to be presented to a user.

FIG. 8 further depicts an upload data use case 818. This aspect of the invention relates to the subscriber's ability to obtain data contained in the search result in various alternative formats (e.g., tabular form, spreadsheets, tab delimited data, as discussed with reference to FIG. 5).

In the embodiment of the invention depicted in FIG. 8, aspects of the invention that relate to the gathering of datasets are illustrated. In particular, a DBA, referred to as a Researcher 820 in the figure, interacts with a search and download use case 822 and a generate scripts use case 824. The use of scripts to transform raw data was discussed above with respect to FIG. 1B. FIG. 8 also illustrates how these data sets are updated using the obtain updates use case 826.

The select ad use case 816 relies on information in addition to that provided by the detect trend use case 814. In particular, an Advertiser 830 provides the system with advertisements (upload ads use case 834) and associate rules (upload rules use case 832) which are employed by the select ad use case 816 to determine which ads are to be presented. A statistics use case 836 is also utilized by the system to, among other things, track the particular ads displayed.

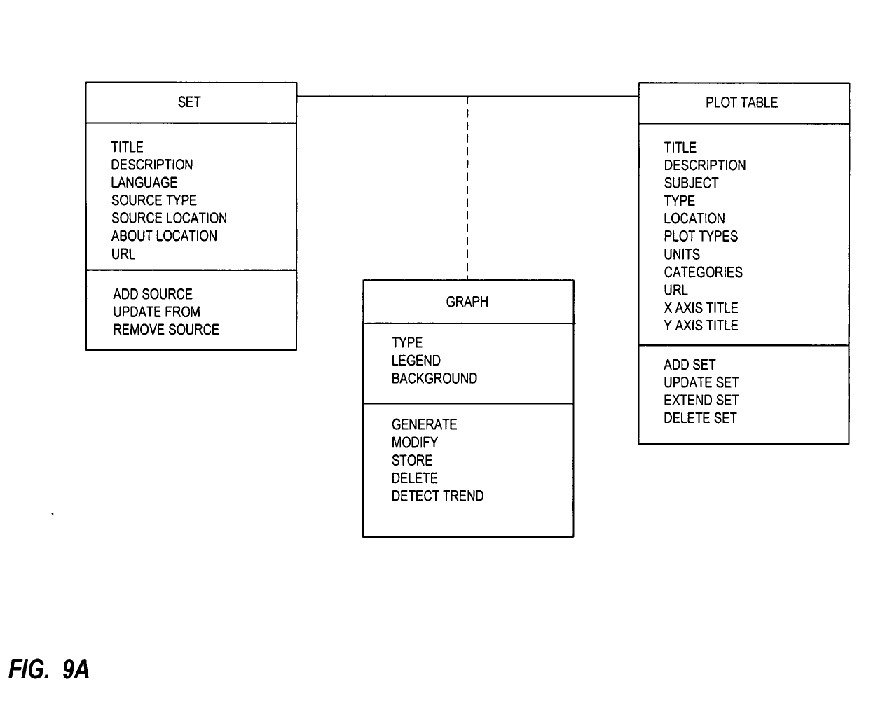

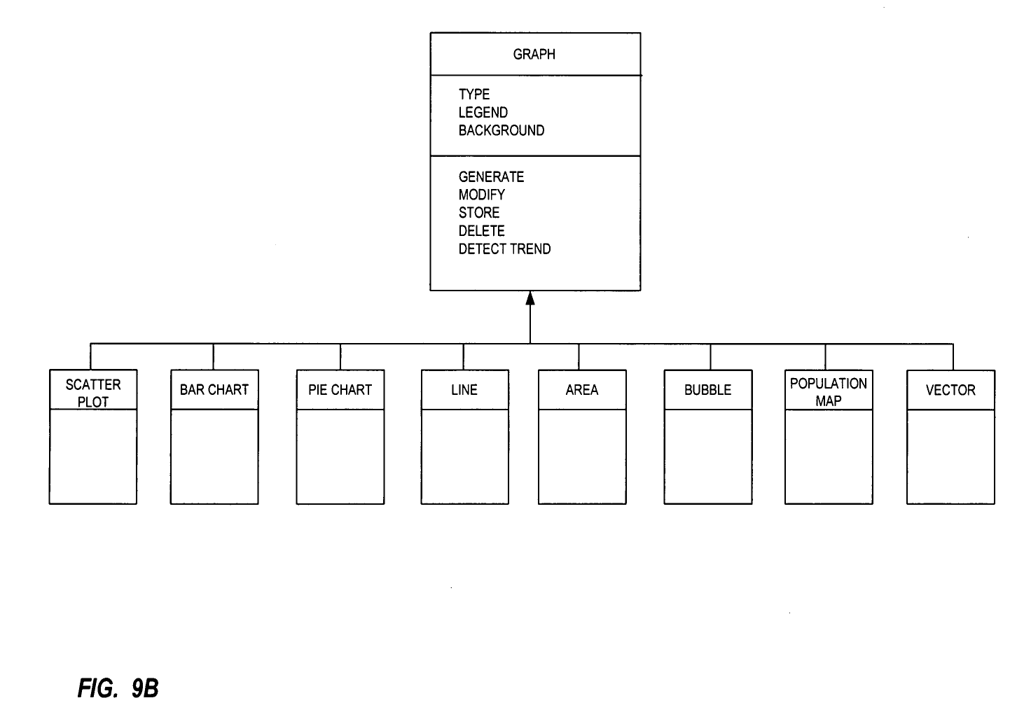

The attributes and operations of various aspects of the present invention are illustrated in class diagrams of FIGS. 9A & 9B. These class diagrams are also considered as part of the UML, and can be used to better describe the data set engine 800. FIG. 9B also depicts the various types of graphs that can be used to display the results.

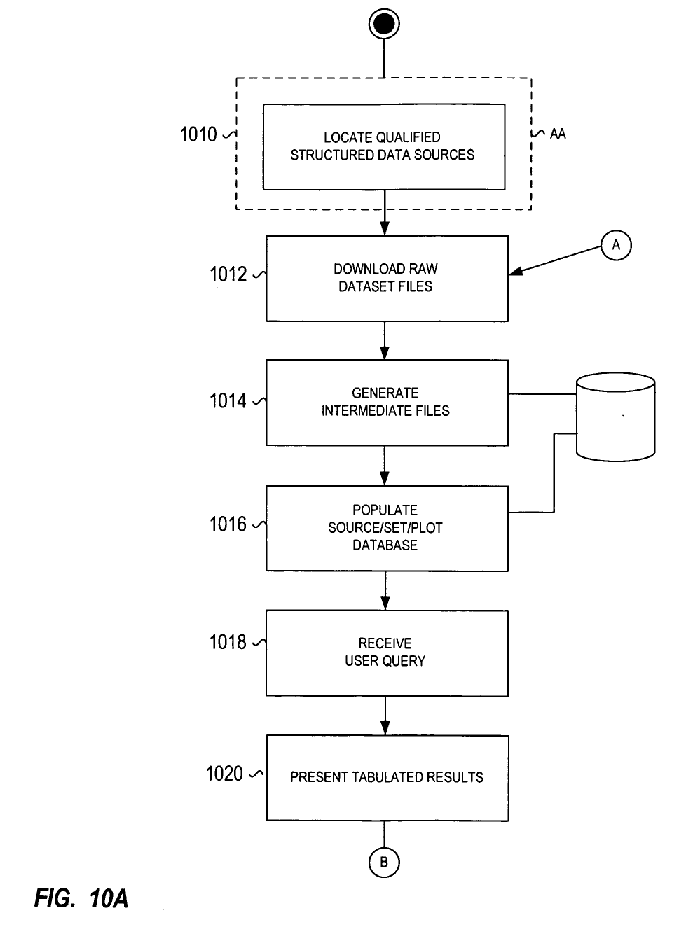

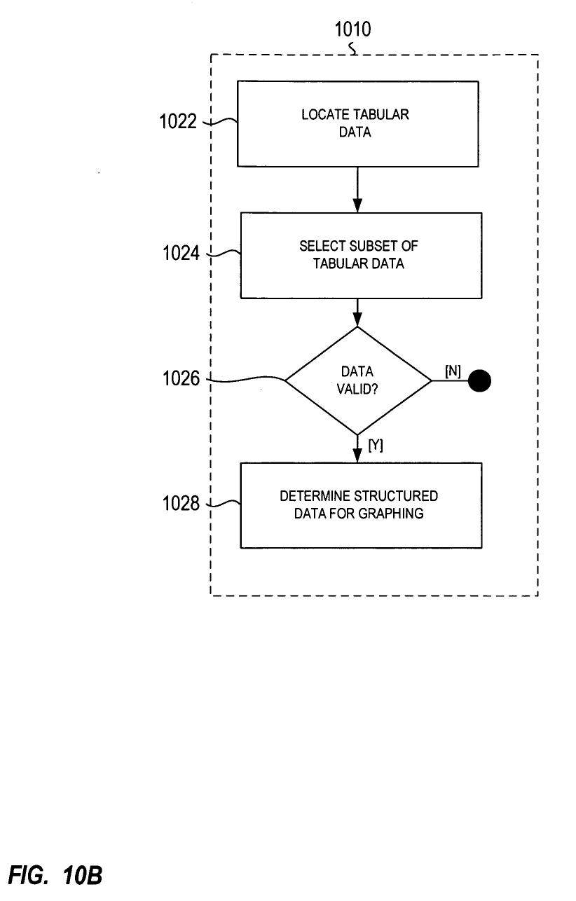

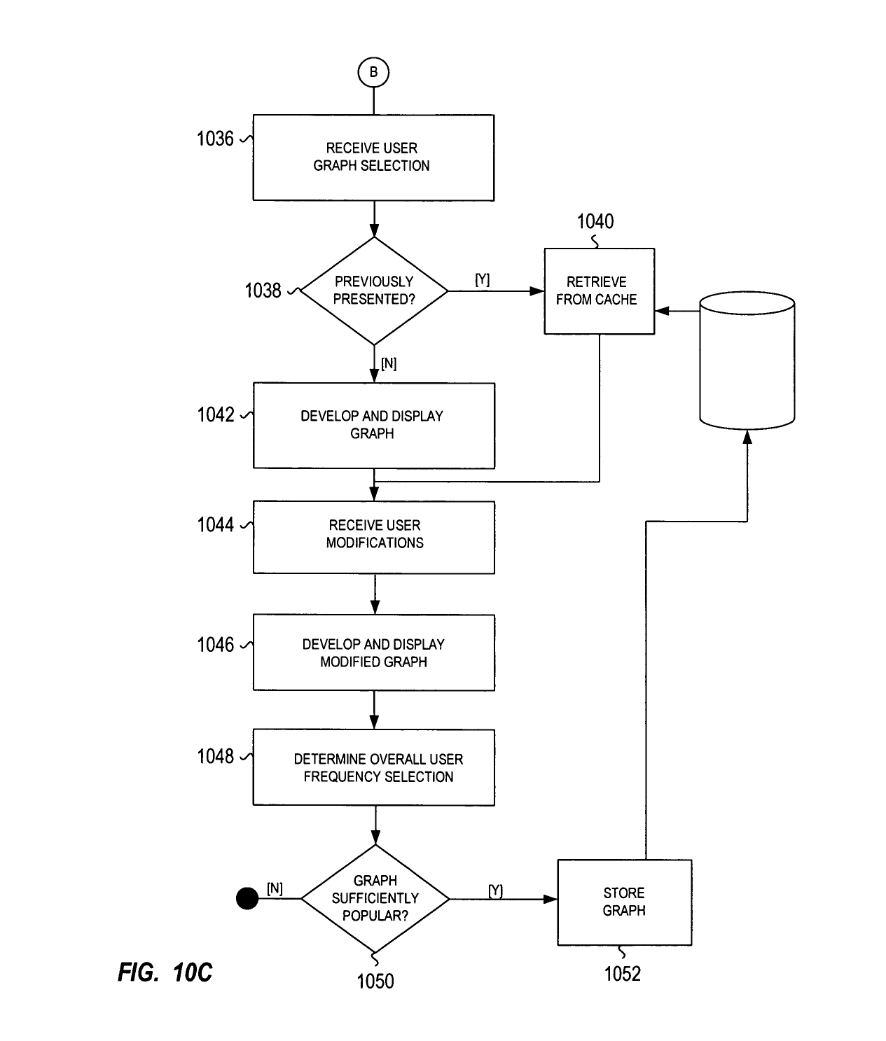

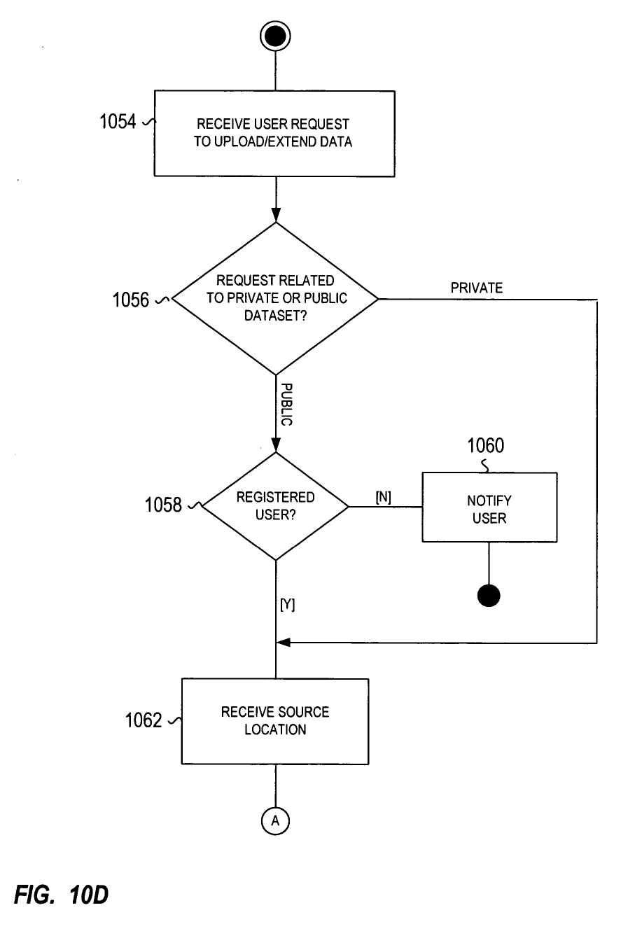

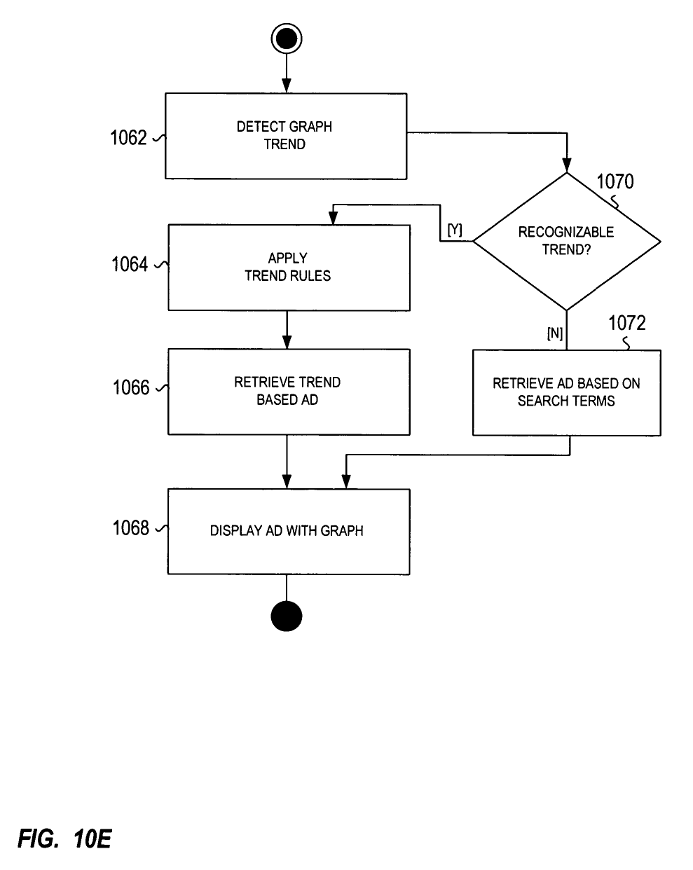

Referring to FIGS. 10A-10E the process is shown for storing data sets and then displaying a graph in response to a user query in accordance with the present method and system. As illustrated in step 1010 of FIG. 10A, qualified structured data sources are first located. Raw dataset files are then downloaded 1012 and intermediate files are generated 1014. In step 1016 the source/set/plot database is populated. In step 1018 a query is received from a user and in response, tabulated results are presented in step 1020.

The process continues at step 1036 of FIG. 10C wherein a user makes a graph selection. At step 1038 it is determined if the requested graph has been presented previously. If it has, the graph is retrieved from a cache at step 1040. If it has not, a graph is developed and presented to the user at step 1042. Any user modifications are received at step 1044, and the modified graph is displayed at step 1046. The system further determines the frequency of the user graph selection at step 1048 and if sufficiently popular, stores the graph in the cache (steps 1050 and 1052, respectively).

FIG. 10B depicts step 1010 in greater detail. In particular, a set of tabular data is located at step 1022 and a subset of that data is selected at step 1024. As defined herein, such a subset may contain the entire set of tabular data. In one embodiment of the invention, the validity of the data is tested at step 1026. If the data is determined to be unreliable, it is not entered.

FIG. 10D depicts an embodiment of the invention wherein the user can request to upload additional data from a source (or sources) that he has identified. At step 1056 the system first determines if the data is to be added to a private or to a public dataset. In the former case, the process continues to step 1062 where the source location is received. If a public dataset is to be augmented, the system next determines if the user is registered and thereby authorized to perform this function. If he is not, his request is denied and he is so notified (step 1060). If he is authorized, the process continues to step 1062 as before.

FIG. 10E illustrates an embodiment of the invention in which an advertisement is selected to be presented with the graph data. At step 1062 the system looks to detect at least one trend associated with the graph display. This may be the nature of the data itself (e.g., price of gold versus time) or even the manner in which it is requested to be displayed (e.g., price in Yen). At step 1064 trend rules are applied against detected trends and one or more corresponding advertisements are then selected (step 1066) and displayed with the graphed data (step 1068).

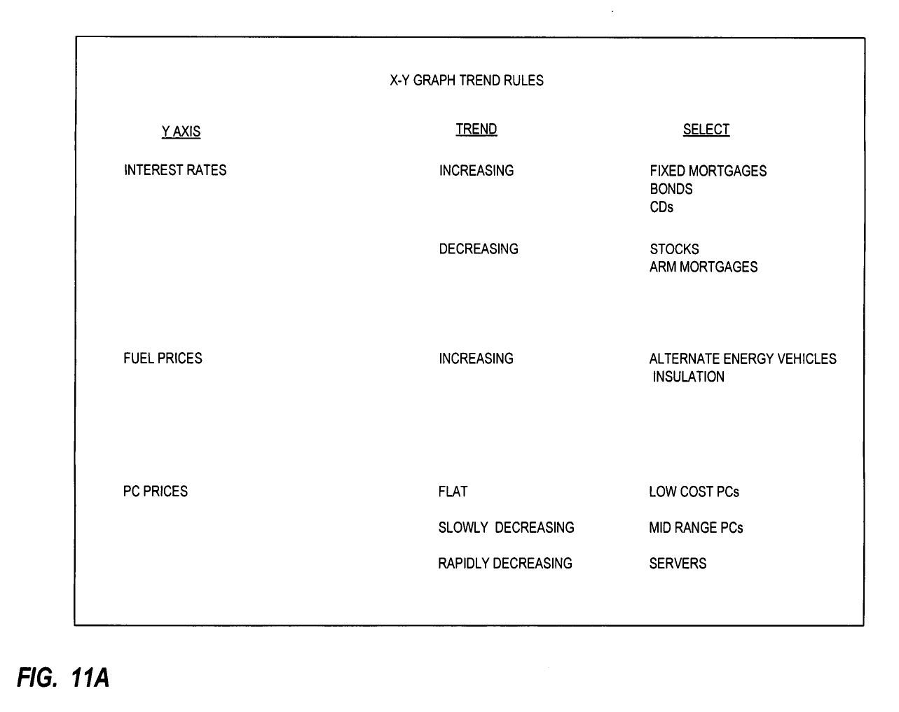

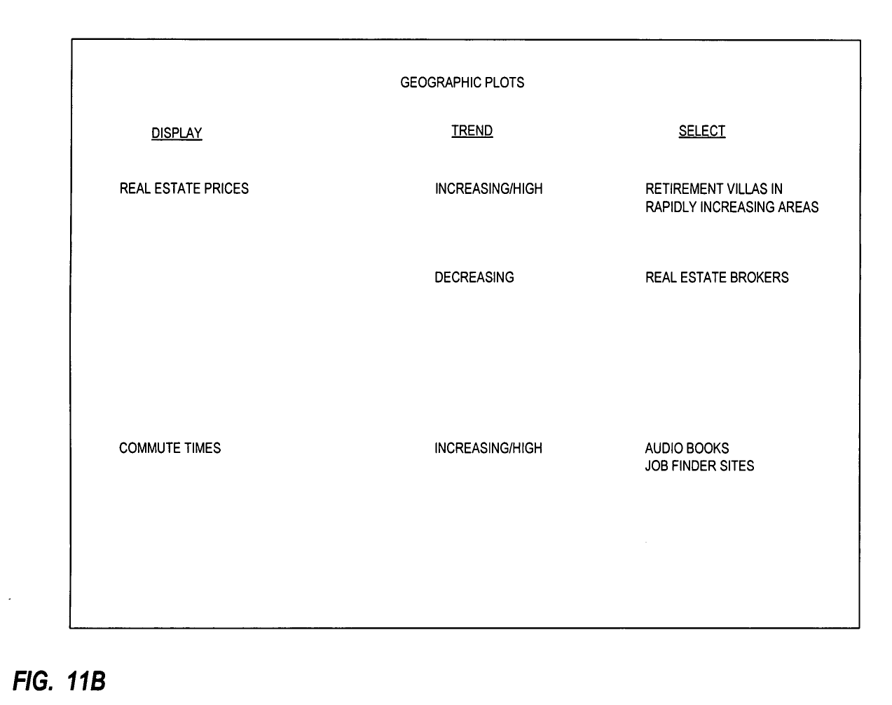

FIG. 11A is an exemplary table of such trend rules that can be employed in a graph having an X and Y axis. By way of example, if a user requests data related to interests rates as a function of time, the system would determine if those rates are increasing or decreasing. In the former case, advertisements related to fixed rate mortgages and purchases of bonds and certificates of deposit would be presented to the user with the graphed data. Should interest rates be declining, advertisements related to adjustable rate mortgages and purchases of stocks would be presented.

FIG. 11B illustrates examples of trend rules that are applicable to geographic data that may be presented in a map format. By way of example, if the data requested indicates a trend of increasing or high real estate prices, the system rules may select an advertisement for retirement villas in an area of rapidly increasing prices. Conversely if the data indicates a decreasing trend in real estate prices, ads for real estate brokers would be displayed along with the user requested real estate price data.

The present invention may be implemented with a variety of combinations of hardware and software. If implemented as a computer-implemented apparatus, the present invention is implemented using means for performing all of the steps and functions described above.

The present invention can be included in an article of manufacture (e.g., one or more computer program products) having, for instance, computer usable media. The media has embodied therein, for instance, computer readable program code means for providing and facilitating the mechanisms of the present invention. The article of manufacture can be included as part of a computer system or sold separately.

Although the description above contains specific examples, these should not be construed as limiting the scope of the invention but as merely providing illustrations of some of the presently preferred embodiments of this invention. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A method for presenting a display of requested data wherein said display comprises at least one graph of the requested data and at least one advertisement, said method comprising:
storing a plurality of advertisements;
storing advertisement selection criteria associated with said plurality of advertisements;
analyzing said requested data to detect one or more trends;
conducting a comparison of characteristics of said one or more trends with said advertisement selection criteria;
selecting at least one of said plurality of advertisements based upon said comparison; and,
presenting at least one of said selected advertisements in said display.

2. The method of claim 1 wherein said one or more trends is derived based on one or more requests of a single user.

3. The method of claim 1 wherein said one or more trends is derived based on requests of more than one user.

4. The method of claim 1 wherein said requested data comprises tabular data and said method further comprises:
locating at least one database source containing the requested tabular data, wherein said source is formatted in a markup language intended for processing by a browser; and,
copying said tabular data from said at least one source to a server.

5. The method of claim 1 further comprising:
providing to a user, interface elements for selection of graphical presentation of said requested data; and,
detecting the user's selected interface elements.

6. The method of claim 1 wherein said analyzing is performed using an analysis selected from the group consisting of regression analysis, spline fitting, and combinations thereof.

7. A method for selecting an advertisement based upon a trend in data selected for graphical presentation, comprising the steps of:
presenting a user interface for entry of textual information representing data of interest to a user;
accepting textual information input containing one or more terms from a user;
locating one or more sets of data corresponding to said one or more terms;
analyzing said sets of data to detect one or more trends;
storing a set of rules that relate trends to advertising characteristics; and,
presenting to the user one or more advertisements, said advertisements having been selected using said rules and said detected trends.

8. A method for selecting advertisements to be presented to a user, said method comprising:
presenting user interface elements for selection of tabular data to be graphically presented;
detecting user selection of said user interface elements;
analyzing said tabular data to detect a trend; and,
selecting an advertisement based upon said detected trend.

9. The method of claim 8 further comprising:
presenting the selected advertisement to the user in a display format which accompanies the graphically presented data.

10. The method of claim 8 further comprising:
creating a data record of the selected advertisement relative to the user.

11. The method of claim 8 wherein said analyzing is performed using an analysis selected from the group consisting of regression analysis, spline fitting, and combinations thereof.

12. A computer-readable medium containing instructions for controlling a data processing system to perform a method for presenting a display of requested data comprising at least one graph of the data and at least one advertisement, said method comprising the steps of:
storing a plurality of advertisements;
storing advertisement selection criteria associated with said plurality of advertisements;
analyzing said requested data to detect one or more trends;
conducting a comparison of characteristics of said one or more trends with said advertisement selection criteria;
selecting at least one of said plurality of advertisements based upon said comparison; and,
presenting at least one of said selected advertisements in said display.

13. The computer-readable medium of claim 12 wherein said requested data comprises tabular data and said method further comprises:
locating at least one database source containing the requested tabular data, wherein said source is formatted in a markup language intended for processing by a browser; and,
copying said tabular data from said at least one source to a server.

14. The computer-readable medium of claim 12, wherein said method further comprises:
providing to a user, interface elements for selection of graphical presentation of said requested data; and,
detecting the user's selected interface elements.

15. A computer-readable medium containing instructions for controlling a data processing system to perform a method for selecting an advertisement based upon a trend in data selected for graphical presentation, said method comprising the steps of:
presenting a user interface for entry of textual information representing data of interest to a user;
accepting textual information input containing one or more terms from a user;
locating one or more sets of data corresponding to said one or more terms;
analyzing said sets of data to detect one or more trends;
storing a set of rules that relate trends to advertising characteristics; and,
presenting to the user one or more advertisements, said advertisements having been selected using said rules and said detected trends.

16. A computer-readable medium containing instructions for controlling a data processing system to perform a method for selecting advertisements to be presented to a user, said method comprising the steps of:
presenting user interface elements for selection of tabular data to be graphically presented;
detecting user selection of said user interface elements;
analyzing said tabular data to detect a trend;
selecting an advertisement based upon said detected trend; and,
presenting the selected advertisement to the user in a display format which accompanies the graphically presented data.

17. The computer-readable medium of claim 16 further comprising the step of creating a data record of the selected advertisement relative to the user.

18. An apparatus for presenting a display of requested data wherein said display comprises at least one graph of the requested data and at least one advertisement, said apparatus comprising:
a database containing a plurality of advertisements;
a database containing advertisement selection criteria associated with said plurality of advertisements;
a means for analyzing said requested data to detect one or more trends;
a means for conducting a comparison of characteristics of said one or more trends with said advertisement selection criteria;
a means for selecting at least one of said plurality of advertisements based upon said comparison; and,
a display device for presenting at least one of said selected advertisements in said display.

19. The apparatus of claim 18 wherein said requested data comprises tabular data and said apparatus further comprises:
A means for locating at least one database source containing the requested tabular data, wherein said source is formatted in a markup language intended for processing by a browser; and,
A means for copying said tabular data from said at least one source to a server.

20. An apparatus for selecting advertisements to be presented to a user, said apparatus comprising:
a means for presenting user interface elements for selection of tabular data to be graphically presented;
a means for detecting user selection of said user interface elements;
a means for analyzing said tabular data to detect a trend;
a means for selecting an advertisement based upon said detected trend; and,
a means for presenting the selected advertisement to the user in a display format which accompanies the graphically presented data.
